(19) United States
(12) Patent Application Publication
(10) Pub. No.: US 2006/0043737 A1
(43) Pub. Date: Mar. 2, 2006

(54) Integrated power pole

(76) Inventor: Daniel Ashikian, Van Nuys, CA (US)

Correspondence Address: Daniel Ashikian, 1638 N. San Fernando Blvd, Burbank, CA, 91504-4122, US

(21) Appl. No.: 10/924,126

(22) Filed: Aug. 24, 2004

(51) Int. Cl. F03D 9/00; H02P 9/04

(52) U.S. Cl. 290/44

(57) ABSTRACT

Self powered Integrated Power Pole converting solar, wind, thermal and compressed air energy into consumable electrical power for application uses with any high mounted device that requires electrical power to function. The present invention relates generally to a self propelled power device for use in any high mounted outdoor fixture and/or equipment, which does not generate any harmful, polluting residue. It is cost-effective, pays off by itself and will save tremendous amount of the other types of energy resources. It is extremely ecologically aware in operation and design. The primary applications for integrated power poles are outdoor lighting, traffic signal lights, safety signals and high mounted communication and data repeaters.

### BACKGROUND OF THE INVENTION

Generally, power poles for street lighting, traffic signal lights, safety signals and high mounted communication repeaters etc became necessity for the proper functioning of our everyday life. However, all of this requires use of energy, which is limited on our planet. Energy uses creates serious problems. They include the depletion of fossil fuel reserves and negative environmental effects. Existing street lighting systems depends on central utility power grids, which mainly use fossil fuels to generate electricity. There are also many other disadvantages to using a centralized power system. If there was an accident and a black out accurred, several blocks of streets would be inoperative because of a single problem persisting in the central unit.

In summarizing all of these disadvantages, it is important to develop self sufficient energy sources. The most efficient and environmentally friendly sources of energy are the sun's radiated energy and wind energy. But, to provide continuous electrical power at any instance we must have sunlight or the wind persistently. Unfortunately, the wind and sunlight are not stable during the day and when they are present their intensity is ether too high or too low. That is why it is essential to have a fast charging battery back up to compensate for the inconsistency of power generation.

The Integrated Power Pole solves all of these problems by integrating solar panels, wind generators, thermocouples and a Thermo-Dynamic Battery to generate, store and regenerate the energy for high mounted outdoor fixtures and equipment that require electrical power to operate. Conventional outdoor poles as a rule and regulation are made with the materials strong enough to resist the winds for safety, same as to hold pressure. Another feature is that these poles have empty air space inside the pole which is big enough to compress air and store a substantial amount of energy for use in demand to supply continuous power. The other positive feature of the poles are that they have to be high to cover more lighted space or to send the communication signals farther to cover more air space, this makes it an excellent match to mount at the top of the poles small wind and solar panels to generate, collect and store energy in form of compressed air.

Accordingly, the present invention relates generally to a self propelled power device for use in any high mounted outdoor fixture and/or equipment, which does not generate any harmful, polluting residue. It is cost-effective, pays off by itself and will save tremendous amounts of the other types of energy resources. It is extremely ecologically aware in operation and design.

### OBJECTS OF THE INVENTION

The present invention relates in general to a new self powered device. More distinctively, it provides generation of electrical power from sunlight, wind, thermal and compressed air.

Another positive attribute of the present invention is the reality that the Sun, Air and Wind are highly available everywhere and unlimited for the use of powering the high mounted outdoor fixtures and equipment.

Another positive attribute of the present invention is that power poles are tall, strong and large enough to use as a compressed air battery and to attach wind and solar panels at the top.

Another positive attribute of the present invention is that thermocouple generators are sensitive to temperature drops and will generate substantial energy to increase overall system efficiency.

Another positive attribute of the present invention is that integrating four low energy output devices together and optimizing the system, makes this device highly efficient and environmentally very friendly, because it does not emit any harmful residue.

Another positive attribute of the present invention is that independent power poles will make a safer environment around populated vicinity.

### SUMMARY OF THE INVENTION

The present invention provides a unique uninterruptible power supply, which is powered by usable solar, wind, thermal and compressed air energy for use in any high mounted outdoor fixture and/or equipment that requires electrical power to operate.

A method in accordance with the invention comprises providing at least one photovoltaic (PV) solar panel, at least one wind generator, at least one thermo-dynamic battery, at least one thermocouple generator and at least one compressor for generating, storing and regenerating electrical power from sun, air and wind for use in any high mounted outdoor fixture and/or equipment that requires electrical power to operate.

The present invention saves much more energy for the same energy output as the conventional high mounted fixtures and/or equipment. It is low-maintenance, low-cost and pays-off by itself, environmentally friendly and increases the safety of our surroundings.

### BRIEF DESCRIPTION OF DRAWINGS

FIG. 1 is a block diagram showing the components of the Integrated Power Pole in accordance of present invention.

FIG. 2 is side view of the Integrated Power Pole in accordance with the present invention.

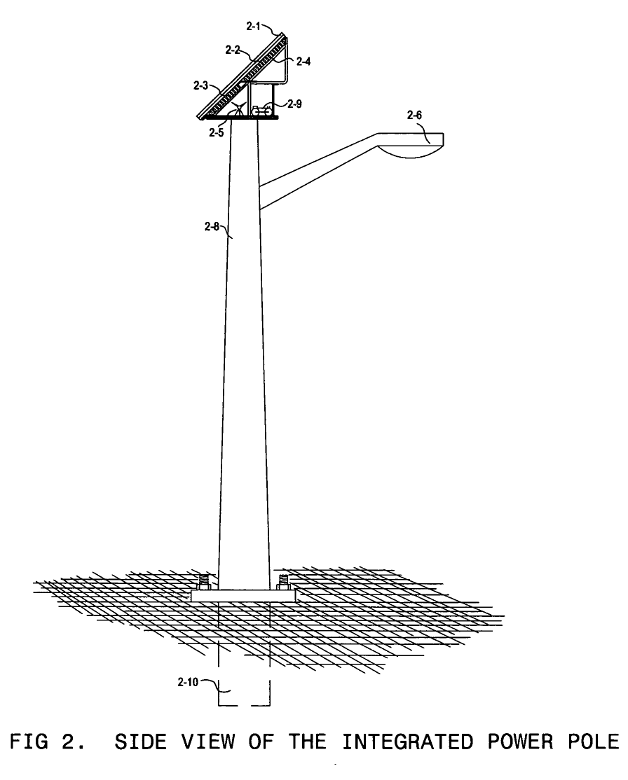

### DETAILED DESCRIPTION OF THE INVENTION

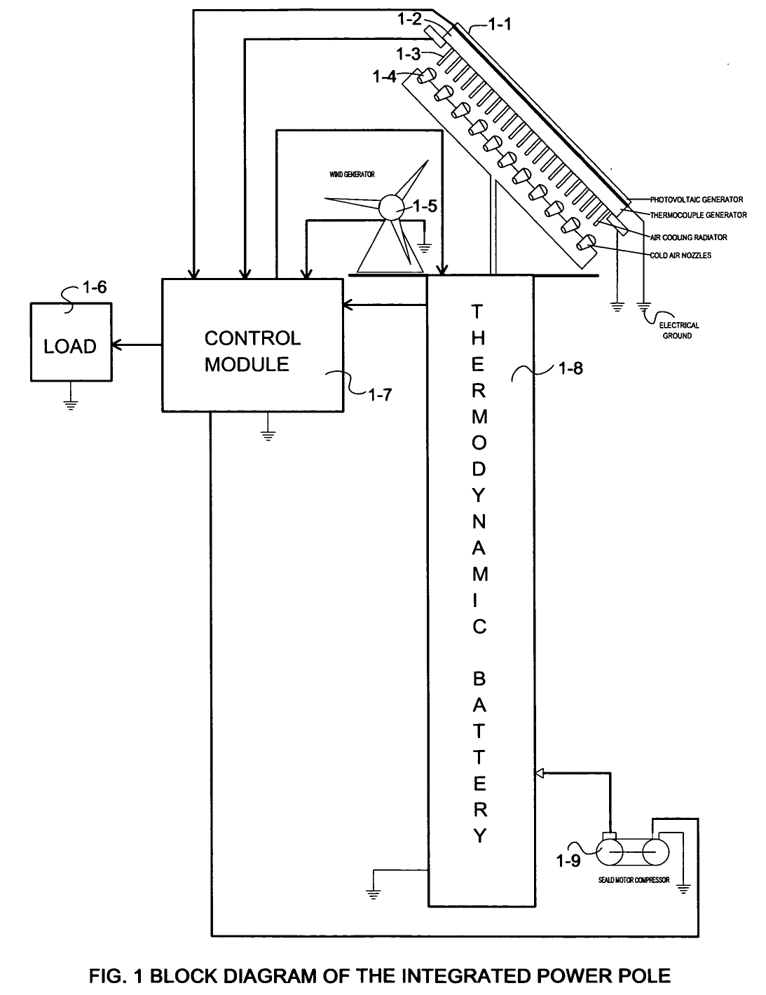

As shown FIG. 1 Integrated Power Pole in accordance with the invention comprises:
1. Compressed Air Battery 1-8 to store energy
2. Air compressor 1-9 for charging the battery
3. Photovoltaic (PV) Panel 1-1 to generate electrical power
4. Wind Generator 1-5 to generate electrical power
5. Thermocoupling Generator 1-2 simultaneously generating electricity and cooling down PV panel.
6. Air vent nozzle 1-4 for cooling thermocouples
7. Control Module 1-7 to manage the power generation and load 1-6 demand
8. Air cooled radiator 1-3 to maintain temperature difference at the thermocouples relative to ambient temperature

The control module 1-7 turns on the air compressor 1-9 to charge the thermo-dynamic battery 1-8 whenever there is extra energy generation. And when the generation is low or cuts-off the control module turns on the thermo-dynamic battery to compensate the power deficiency. To increase PV panel 1-1 performance the thermocouples 1-2 are mounted behind the PV panel. Opposite surfaces of thermocouples is mounted air cooled radiator 1-3. This arrangement creates temperature difference at the thermocouples and will decrease the PV panel temperature. The temperature difference at the thermocouples creates the electrical power generation and decreasing PV panel temperature will improve the efficiency of the PV panels. PV modules operating under the sun will heat up substantially, reaching inner temperatures of 50-70 degrees centigrade. For crystalline modules power output reduces as much as 11% typically. Thermocouple modules, mounted behind the PV modules, decrease PV module temperature and improves the PV module performance, simultaneously the temperature different at the sides of thermocouple module will stimulate generating electricity. Vented cold air from compressed air battery is directed by the air vent nozzle 1-4 into the air cooled radiator 1-3 surface which will create large temperature different at the thermocouples relative to ambient temperature of surroundings. This will force thermocouples to generate extra energy and the overall system efficiency will increase. It is studied that the vented air from compressed air battery becoming minimum 25 degrees centigrade colder than ambient temperature. With this temperature difference we need 0.008 square meter space for thermocouple modules to generate 1 watt energy. This arrangement optimizes the space needed at the top of the pole to generate energy.

The underground part 2-10 of compressed air battery can be different sizes for appropriate power demand applications. Increasing the underground section size of compressed air battery will increase the stability of the power pole against the winds and reliability of the power supply.

It has been observed that during the winter the daylight is short but the winds are high and in the summer it is opposite, the daylight is long and the winds are low but it is not excluded that winds and sunlight intensity will be high concurrently all around the year. Therefore integrating small wind generator 1-5 at the top of the pole where most wind energy can be collected increases the overall reliability of Integrated Power Poles.

Another positive attribute of the present invention is that reality direct current (DC) drives and loads are 90% efficient, smaller and lighter in size.

What is claimed is:

1. An Integrated Power Pole device providing an uninterruptible electrical power comprising: at least one thermo-dynamic battery to store energy; at least one electricity generating device; at least one air compressor to charge thermo-dynamic battery; at least one thermocouple module to recover thermo energy in the form of electrical energy.

2. The invention as set forth in claim 1 further including at least one air compressor connectable to thermo-dynamic battery wherein said air compressor charging the thermo-dynamic battery with compressed air.

3. The invention as set forth in claim 1 wherein said at least one electricity generating device includes at least one PV module; at least one wind generator; and at least one thermocouple module.

4. The invention as set forth in claim 1 further including at least one air cooled radiator connectable behind said at least one thermocouple module to keep the temperature different.

5. The invention as set forth in claim 1 wherein said Integrated Power Pole device providing an uninterruptible electrical power comprises at least one control module for managing power generation and demand.

6. The invention as set forth in claim 1 wherein said thermo-dynamic battery embedded inside the pole.

7. A method for recovering thermo energy comprising the steps of:
(a) Heating at least one thermocouple module relative to ambient temperature
(b) Cooling at least one thermocouple module relative to ambient temperature

8. The method as set forth in claim 7 further including the step of heating one side of said at least one thermocouple module and cooling the other side of said at least one thermocouple module.

9. The method as set forth in claim 7 further including the step of cooling one side of said at least one thermocouple module.

10. The heating member as set forth in claim 8 is the PV module.

11. The cooling member as set forth in claim 8 is at least one air cooled radiator.

12. The cooling member as set forth in claim 9 is the vented air from thermo-dynamic battery.
